(19) United States
(12) Patent Application Publication
(10) Pub. No.: US 2024/0191084 A1
(43) Pub. Date: Jun. 13, 2024

(54) ANTIMICROBIAL AND ANTIVIRAL BUILDING PANELS

(71) Applicant: ARMSTRONG WORLD INDUSTRIES, INC., Lancaster, PA (US)

(72) Inventors: Michelle X. WANG, Lititz, PA (US); Ying CHANG, Lancaster, PA (US); John E. HUGHES, Lincoln University, PA (US); Linzhu ZHANG, Ephrata, PA (US); Steven L. MASIA, Lancaster, PA (US)

(21) Appl. No.: 18/538,018

(22) Filed: Dec. 13, 2023

Related U.S. Application Data
(60) Provisional application No. 63/432,155, filed on Dec. 13, 2022.

(51) Int. Cl. C09D 5/14; C08K 3/013; C08K 3/16; C08K 3/38; C09D 7/60; C09D 7/61; C09D 7/65; C09D 157/00; C09D 187/00; E04B 1/92

(52) U.S. Cl. CPC C09D 5/14; C08K 3/013; C08K 3/16; C08K 3/38; C09D 7/60; C09D 7/61; C09D 7/65; C09D 157/00; C09D 187/00; E04B 1/92; C08K 2003/387

(57) ABSTRACT

Described herein is a coating comprising a binder, a pigment, and an antimicrobial composition which comprises particles selected from the group consisting of an aluminum silicate, a magnesium silicate, and a mixture thereof, and wherein the particles are modified with a quaternary ammonium salt. Further described is a building panel and building systems comprising a substrate and the coating composition applied thereto as well as methods of making and using the same.

### CROSS-REFERENCE TO RELATED APPLICATIONS

This application claims the benefit of U.S. Provisional Application No. 63/432,155, filed on Dec. 13, 2022. The disclosure of the above application is incorporated herein by reference.

### BACKGROUND OF THE INVENTION

The presence of bacteria, fungus, and/or viruses on surfaces is a major concern today affecting home, work, and recreational environments. Exposure to certain bacteria, fungi (or their spores), and/or viruses can seriously impact the health of humans, pets and other animals. Previous attempts at imparting protective properties to a building panel included applying an antibacterial and/or antifungal coating to a surface of a building material. However, such previous coatings required relatively large amounts of antibacterial and/or antifungal additives in order to impart sufficient protective activity to the coating, making such coatings expensive as well as yielding negative effects on the aesthetic and/or stability properties of the coating. More so, use of standard antibacterial and/or antifungal additives may have negative consequences on the surrounding environment.

Thus, the need exists for a coating composition that can exhibit adequate protective performance against microbes, fungus, and/or virus exposure while also maintaining stability, aesthetics, and minimizing any negative environmental impact.

### BRIEF SUMMARY OF THE INVENTION

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Applicants have discovered that use of an antimicrobial composition which comprises silicate particles, such as aluminum silicate and/or a magnesium silicate wherein the particles are modified with a quaternary ammonium salt may be incorporated into certain coating compositions to provide for efficacious antibacterial and antiviral properties without detrimental effects to the stability and aesthetic value of the coating or substrate.

Thus, in one aspect, the present invention provides a building panel comprising a substrate comprising a first major surface opposite a second major surface; and a coating atop at least one of the first major surface or the second major surface, the coating comprising: an antimicrobial composition; a binder; and a pigment; wherein the antimicrobial composition comprises particles selected from the group consisting of an aluminum silicate, a magnesium silicate, and a mixture thereof, and wherein the particles are modified with a quaternary ammonium salt. In certain embodiments, the quaternary ammonium salt is selected from tetramethylammonium iodide, trimethyldecylammonium bromide, didecyldimethylammonium bromide (DDAB), dodecyldimethyl-2-phenoxyethylammonium bromide, lauryltrimethylammonium bromide, cetyltrimethylammonium bromide, didecyldimethylammonium chloride (DDAC), trimethylammonium chloride, trimethyldodecylammonium chloride, trimethyltetradecylammonium chloride, cetylpyridinium chloride, trimethylhexadecylammonium chloride, trimethyloctadecylammonium chloride, didecylmonomethylhydroxyethylammonium bromide, alkyldimethylhydroxyethylammonium chlorides, alkyltrimethylammonium bromides, dioctyldimethylammonium chloride, dioctyldimethylammonium bromide, octyldecyldimethylammonium chloride, octyldecyldimethylammonium bromide, methylbenzethonium chloride, alkyldimethylbenzylammonium chlorides (BAC), alkylpyridiniumammonium chlorides, dialkylmethylbenzylammonium chlorides, didecyldimethylammonium adipate (DDAA), didecyldimethylammonium gluconate, didecyldimethylammonium propionate, N,N-didecyl-N-methyl-poly(oxyethyl)ammonium propionate, didecylmonomethylhydroxyethylammonium adipate, didecylmonomethylhydroxyethylammonium gluconate, didecylmonomethylhydroxyethylammonium sulfonate, alkyldimethylhydroxyethylammonium adipates, alkyldimethylhydroxyethylammonium gluconates, alkyltrimethylammonium adipates, alkyltrimethylammonium gluconates, dioctyldimethylammonium adipate, dioctyldimethylammonium gluconate, octyldecyldimethylammonium adipate, octyldecyldimethylammonium gluconate, didecylmethylpolyoxyethyleneammonium, didecylmethylpolyoxyethyleneammonium gluconate, or didecylmethylpolyoxyethyleneammonium propionate. In certain embodiments, the quaternary ammonium salt is present in an amount from about 0.05 to about 7.5%, from about 0.05 to about 5.0%, from about 0.1 to about 3.0%, from about 0.1 to about 1.0%, or from about 0.1 to about 0.8%, based on the total weight of the coating. In certain embodiments, the quaternary ammonium salt is cetyltrimethylammonium bromide. In certain embodiments, the silicate particle is present in an amount from about 0.3 to about 10.0%, from about 0.3 to about 5.0%, from about 0.3 to about 3.0%, or from about 0.5 to about 2.8%, based on the total weight of the coating. In certain embodiments, the mass ratio of silicate particles to absorbed quaternary ammonium salt is from about 7:1 to about 3:1, from about 6:1 to about 4:1, or from about 5.6:1 to about 3.75:1. In certain embodiments, the particle is a magnesium silicate and comprises sepiolite. In certain embodiments, the antimicrobial composition further comprises docusate. In certain embodiments, the docusate is sodium docusate. In certain embodiments, the docusate is present in an amount from about 0.01% to about 0.5%, from about 0.01% to about 0.3%, or from about 0.01% to about 0.09%, based on the total weight of the coating. In certain embodiments, the antimicrobial composition further comprises silver chloride. In certain embodiments, the silver chloride is present in an amount from about 0.01% to about 1.0%, from about 0.01% to about 0.5%, from about 0.01% to about 0.3%, or from about 0.01% to about 0.09%, based on the total weight of the coating. In certain embodiments, the antimicrobial composition further comprises a metal borate. In certain embodiments, the metal borate is present in an amount from about 8 to about 45 wt. %, based on the total weight of the antimicrobial composition. In certain embodiments, the coating further comprises a hydrophobic agent. In certain embodiments, the hydrophobic agent is selected from a silicon emulsion, a paraffin emulsion, a polyethylene emulsion, a blend of paraffin and polyethylene wax emulsion, and combinations or two or more thereof. In certain embodiments, the hydrophobic agent is present in an amount from about 1.0 to about 10.0%, from about 1.0 to about 8.0%, from about 1.0 to about 6.5%, or from about 1.0 to about 2.0%, based on the total weight of the coating. In certain embodiments, the antimicrobial composition is present in an amount from about 0.3 to about 50%, from about 0.3 to about 10%, from about 0.3 to about 8%, from about 0.3 to about 5%, from about 0.3 to about 3%, from about 5 to about 20%, or from about 7 to about 15%, based on the total weight of the coating. In certain embodiments, the coating is present on the substrate in an amount ranging from about 50 g/m² to about 400 g/m². In certain embodiments, the pigment is present in an amount ranging from about 10 to about 25%, based on the total weight of the coating. In certain embodiments, the coating further comprises a filler. In certain embodiments, the filler is selected from calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, zinc sulfate, and mixtures of two or more thereof. In certain embodiments, the filler is present in an amount ranging from about 25 to about 80%, from about 25 to about 60%, from about 30 to about 55%, or from about 30 to about 50%, based on the total weight of the coating. In certain embodiments, the binder comprises a polymeric binder. In certain embodiments, the polymeric binder is selected from vinyl acetate, vinyl propionate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methacrylate, hydroxyethyl acrylate, styrene, butadiene, urethane, epoxy, melamine, and a mixture of two or more thereof. In certain embodiments, the polymeric binder is a homopolymer of carboxylated polyvinyl acetate. In certain embodiments, the polymeric binder is present in an amount ranging from about 8 to about 20%, from about 10 to about 17%, or from about 10 to about 15%, based on the total weight of the coating. In certain embodiments, the coating further comprises a dispersant. In certain embodiments, the dispersant is an anionic polyacrylamide. In certain embodiments, the dispersant is present in an amount ranging from about 0.05 to about 2.0%, from about 0.05 to about 1.0%, or from about 0.05 to about 0.5%, based on the total weight of the coating. In certain embodiments, the coating further comprises a water soluble cellulose ether. In certain embodiments, the water soluble cellulose ether is present in an amount ranging from about 0.05 to about 2.0%, from about 0.05 to about 1.0%, or from about 0.05 to about 0.5%, based on the total weight of the coating. In certain embodiments, the coating further comprises a defoamer. In certain embodiments, the defoamer is a polyether siloxane. In certain embodiments, the defoamer is present in an amount ranging from about 0.01 to about 0.5%, based on the total weight of the coating. In certain embodiments, the substrate is a porous structure and the building panel is an acoustical ceiling panel. In certain embodiments, the porous structure comprises a fibrous material. In certain embodiments, the antimicrobial composition is free of biocides other than the modified particles. In certain embodiments, the antimicrobial composition is free of triazole compounds. In certain embodiments, the building panel exhibits an NRC value of at least 0.65. In certain embodiments, the invention is directed to a ceiling system comprising: a support frame; and at least one building panel according to any one of the embodiments described herein, wherein the building panel is supported by the support frame.

In further aspects, the invention is directed to a coating composition comprising: a liquid carrier; an antimicrobial composition; a binder; and a pigment; wherein the antimicrobial composition comprises particles selected from the group consisting of an aluminum silicate, a magnesium silicate, and a mixture thereof, and wherein the particles are modified with a quaternary ammonium salt. In certain embodiments, the quaternary ammonium salt is selected from tetramethylammonium iodide, trimethyldecylammonium bromide, didecyldimethylammonium bromide (DDAB), dodecyldimethyl-2-phenoxyethylammonium bromide, lauryltrimethylammonium bromide, cetyltrimethylammonium bromide, didecyldimethylammonium chloride (DDAC), trimethylammonium chloride, trimethyldodecylammonium chloride, trimethyltetradecylammonium chloride, cetylpyridinium chloride, trimethylhexadecylammonium chloride, trimethyloctadecylammonium chloride, didecylmonomethylhydroxyethylammonium bromide, alkyldimethylhydroxyethylammonium chlorides, alkyltrimethylammonium bromides, dioctyldimethylammonium chloride, dioctyldimethylammonium bromide, octyldecyldimethylammonium chloride, octyldecyldimethylammonium bromide, methylbenzethonium chloride, alkyldimethylbenzylammonium chlorides (BAC), alkylpyridiniumammonium chlorides, dialkylmethylbenzylammonium chlorides, didecyldimethylammonium adipate (DDAA), didecyldimethylammonium gluconate, didecyldimethylammonium propionate, N,N-didecyl-N-methyl-poly(oxyethyl)ammonium propionate, didecylmonomethylhydroxyethylammonium adipate, didecylmonomethylhydroxyethylammonium gluconate, didecylmonomethylhydroxyethylammonium sulfonate, alkyldimethylhydroxyethylammonium adipates, alkyldimethylhydroxyethylammonium gluconates, alkyltrimethylammonium adipates, alkyltrimethylammonium gluconates, dioctyldimethylammonium adipate, dioctyldimethylammonium gluconate, octyldecyldimethylammonium adipate, octyldecyldimethylammonium gluconate, didecylmethylpolyoxyethyleneammonium, didecylmethylpolyoxyethyleneammonium gluconate, or didecylmethylpolyoxyethyleneammonium propionate. In certain embodiments, the quaternary ammonium salt is present in an amount about 0.05 to about 7.5%, from about 0.05 to about 5.0%, from about 0.1 to about 3.0%, from about 0.1 to about 1.0%, or from about 0.1 to about 0.8%, based on the total weight of the coating. In certain embodiments, the quaternary ammonium salt is cetyltrimethylammonium bromide. In certain embodiments, the silicate particle is present in an amount from about 0.3 to about 10.0%, from about 0.3 to about 5.0%, from about 0.3 to about 3.0%, or from about 0.5 to about 2.8%, based on the total weight of the coating. In certain embodiments, the mass ratio of silicate particles to absorbed quaternary ammonium salt is from about 7:1 to about 3:1, from about 6:1 to about 4:1, or from about 5.6:1 to about 3.75:1. In certain embodiments, the particle is a magnesium silicate and comprises sepiolite. In certain embodiments, the antimicrobial composition further comprises docusate. In certain embodiments, the docusate is sodium docusate. In certain embodiments, the docusate is present in an amount from about 0.01% to about 0.5%, from about 0.01% to about 0.3%, or from about 0.01% to about 0.09%, based on the total weight of the coating. In certain embodiments, the antimicrobial composition further comprises silver chloride. In certain embodiments, the silver chloride is present in an amount from about 0.01% to about 1.0%, from about 0.01% to about 0.5%, from about 0.01% to about 0.3%, or from about 0.01% to about 0.09%, based on the total weight of the coating. In certain embodiments, the antimicrobial composition further comprises a metal borate. In certain embodiments, the metal borate is present in an amount from about 8 to about 45 wt. %, based on the total weight of the antimicrobial composition. In certain embodiments, the coating further comprises a hydrophobic agent. In certain embodiments, the hydrophobic agent is selected from a silicon emulsion, a paraffin emulsion, a polyethylene emulsion, a blend of paraffin and polyethylene wax emulsion, and combinations of two or more thereof. In certain embodiments, the hydrophobic agent is present in an amount from about 1.0 to about 10.0%, from about 1.0 to about 8.0%, from about 1.0 to about 6.5%, or from about 1.0 to about 2.0%, based on the total weight of the coating. In certain embodiments, the antimicrobial composition is present in an amount from about 0.3 to about 50%, from about 0.3 to about 10%, from about 0.3 to about 8%, from about 0.3 to about 5%, from about 0.3 to about 3%, from about 5 to about 20%, or from about 7 to about 15%, based on the total weight of the coating. In certain embodiments, the coating is present on the substrate in an amount ranging from about 50 g/m² to about 400 g/m². In certain embodiments, the pigment is present in an amount ranging from about 10 to about 25%, based on the total weight of the coating. In certain embodiments, the coating further comprises a filler. In certain embodiments, the filler is selected from calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, zinc sulfate, and mixtures of two or more thereof. In certain embodiments, the filler is present in an amount ranging from about 25 to about 80%, from about 25 to about 60%, from about 30 to about 55%, or from about 30 to about 50%, based on the total weight of the coating. In certain embodiments, the binder comprises a polymeric binder. In certain embodiments, the polymeric binder is selected from vinyl acetate, vinyl propionate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methacrylate, hydroxyethyl acrylate, styrene, butadiene, urethane, epoxy, melamine, and a mixture of two or more thereof. In certain embodiments, the polymeric binder is a homopolymer of carboxylated polyvinyl acetate. In certain embodiments, the polymeric binder is present in an amount ranging from about 8 to about 20%, from about 10 to about 17%, or from about 10 to about 15%, based on the total weight of the coating. In certain embodiments, the coating further comprises a dispersant. In certain embodiments, the dispersant is an anionic polyacrylamide. In certain embodiments, the dispersant is present in an amount ranging from about 0.05 to about 2.0%, from about 0.05 to about 1.0%, or from about 0.05 to about 0.5%, based on the total weight of the coating. In certain embodiments, the coating further comprises a water soluble cellulose ether. In certain embodiments, the water soluble cellulose ether is present in an amount ranging from about 0.05 to about 2.0%, from about 0.05 to about 1.0%, or from about 0.05 to about 0.5%, based on the total weight of the coating. In certain embodiments, the coating further comprises a defoamer. In certain embodiments, the defoamer is a polyether siloxane. In certain embodiments, the defoamer is present in an amount ranging from about 0.01 to about 0.5%, based on the total weight of the coating. In certain embodiments, the antimicrobial composition is free of biocides other than the modified particles. In certain embodiments, the antimicrobial composition is free of triazole compounds. In certain embodiments, the liquid carrier is water. In certain embodiments, the invention is directed to a method of forming a coating composition according to any one of the embodiments disclosed herein, wherein the method comprises mixing the components with a liquid carrier. In certain embodiments, the components are mixed with the liquid carrier to achieve a total solids amount of from about 60 to about 66 wt. %. In further aspects, the invention is directed towards a method of forming a coated building panel comprising applying the coating composition according to any one of claims 42 to 79 to a substrate; and drying the coating composition so that substantially all liquid carrier is removed to form the coated building panel. In certain embodiments, the substrate comprises a fibrous body. In certain embodiments, the drying is performed at a temperature ranging from about 80° C. to about 135° C.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The detailed description of the invention will be better understood when read in conjunction with the appended drawings. It should be understood, however, that the invention is not limited to the precise arrangements and instrumentalities of the embodiments shown in the drawings.

FIG. 1 is top perspective view of a building panel according to the present invention;

FIG. 2 is a cross-sectional view of the building panel according to the present invention, the cross-sectional view being along the II line set forth in FIG. 1; and

FIG. 3 is a ceiling system comprising the building panel of the present invention.

### DETAILED DESCRIPTION OF THE INVENTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other applications and methods. It is to be understood that the invention is not limited in its application to the details of any particular embodiment shown. The terminology used herein is for the purpose of description and not to limit the invention, its application, or uses.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, “containing”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range.

Unless otherwise specified, all percentages and amounts expressed herein and elsewhere in the specification should be understood to refer to percentages by weight of the total composition. Reference to a molecule, or to molecules, being present at a “wt. %” refers to the amount of that molecule, or molecules, present in the composition based on the total weight of the composition. Unless otherwise specified, the amounts given are based on the active weight of the material.

According to the present application, use of the term “about” in conjunction with a numeral value refers to a value that may be +/−5% of that numeral. As used herein, the term “substantially free” is intended to mean an amount less than about 5.0 weight %, less than 3.0 weight %, 1.0 wt. %; preferably less than about 0.5 wt. %, and more preferably less than about 0.25 wt. % of the composition.

The following description of the preferred embodiment(s) is merely exemplary in nature and is in no way intended to limit the invention, its application, or uses.

Unless defined otherwise, all technical and scientific terms used herein have the same meanings as commonly understood by one of ordinary skill in the art to which this invention belongs. All patents, patent applications, publications, and other references cited or referred to herein are incorporated by reference in their entireties for all purposes. In the event of a conflict in a definition in the present disclosure and that of a cited reference, the present disclosure controls.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus, or system, be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

In certain aspects, the present invention is directed to a surface coating (also referred to as the “coating”) that exhibits antimicrobial, antiviral, and/or antifungal activity while also maintaining stability and aesthetics. According to the present invention, a “microbe” may refer to a fungi source (e.g., mildew, mold), bacteria or bacterial growth, or a virus (a submicroscopic infectious agent that replicates only inside the living cells of an organism). According to the present invention, the term “antimicrobial activity” refers to a reduction in activity of a virus source, a bacteria source or growth, and/or a fungi source or growth. Accordingly, unless stated otherwise, the term antimicrobial activity may refer to “antiviral,” “antibacterial,” and/or “antifungal” activity.

As described in greater detail herein, the surface coating may be applied such that the coating forms a portion of a coated building panel. The building panel may form part of a building system, whereby the building panel forms a ceiling panel or a wall panel.

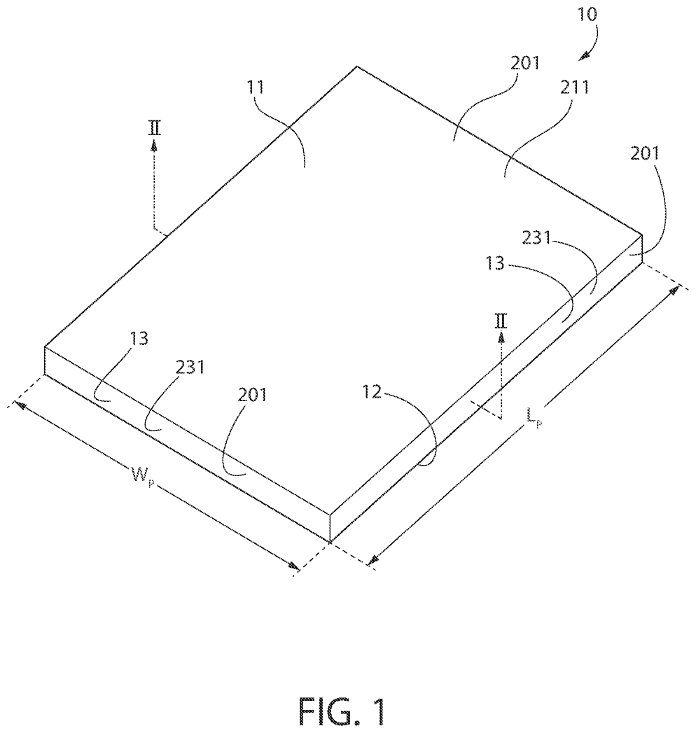

Referring to FIGS. 1-3, building panel 10 comprising a first major exposed surface 11 opposite a second major exposed surface 12 and a side exposed surface 13 that extends between the first major exposed surface 11 and the second major exposed surface 12, thereby defining a perimeter of the ceiling panel 10.

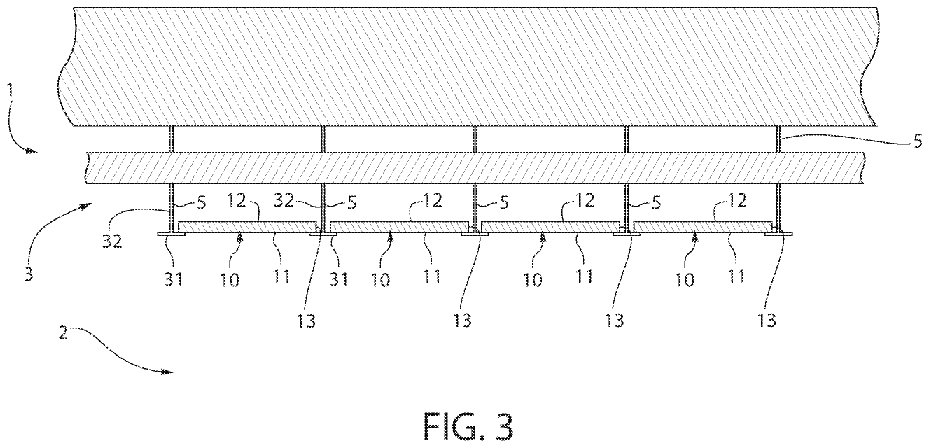

Referring to FIG. 3, the present invention may further include a ceiling system 1 comprising one or more of the building panels 10 installed in an interior space, whereby the interior space comprises a plenum space 3 and an active room environment 2. In such embodiments, the building panel 10 may be referenced as a ceiling panel 10. The plenum space 3 provides space for mechanical lines within a building (e.g., HVAC, plumbing, etc.). The active space 2 provides room for the building occupants during normal intended use of the building (e.g., in an office building, the active space would be occupied by offices containing computers, lamps, etc.).

In the installed state, the building panels 10 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some embodiments, the plurality of second struts intersects the plurality of first struts to create an intersecting ceiling support grid. The plenum space 3 exists above the ceiling support grid and the active room environment 2 exists below the ceiling support grid. In the installed state, the first major exposed surface 11 of the building panel 10 may face the active room environment 2 and the second major exposed surface 12 of the building panel 10 may face the plenum space 3.

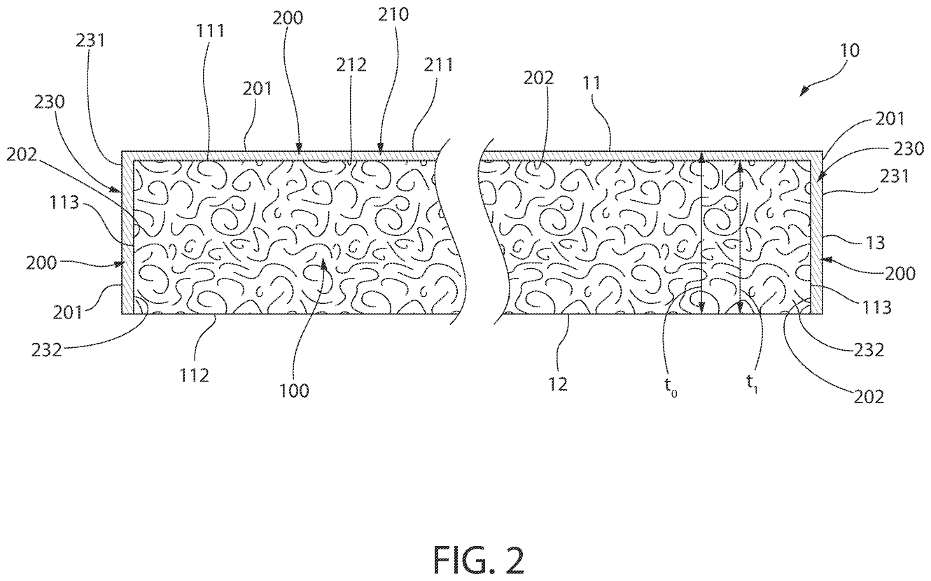

Referring now to FIGS. 1 and 2, the building panel 10 of the present invention may have a panel thickness to as measured from the first major exposed surface 11 to the second major exposed surface 12. The panel thickness to may range from about 12 mm to about 40 mm—including all values and sub-ranges there-between. The building panel 10 may have a length L_{P} ranging from about 30 cm to about 310 cm—including all values and sub-ranges there-between. The building panel 100 may have a width W_{P} ranging from about 10 cm to about 125 cm—including all values and sub-ranges there-between.

The building panel 10 may comprise a body 100 and a surface coating 200 applied thereto—as discussed further herein. The body 100 comprises an upper surface 111 opposite a lower surface 112 and a body side surface 113 that extends between the upper surface 111 and the lower surface 112, thereby defining a perimeter of the body 100. The body 100 may have a body thickness ti as measured by the distance between the upper surface 111 to the lower surface 112 of the body 100. The body thickness ti may range from about 12 mm to about 40 mm—including all values and sub-ranges there-between.

The body 100 may be porous, thereby allowing airflow through the body 100 between the upper surface 111 and the lower surface 122—as discussed further herein. The body 100 may be comprised of a binder and fibers. In some embodiments, the body 100 may further comprise a filler and/or additive.

Non-limiting examples of binder suitable for the body 100 may include a starch-based polymer, polyvinyl alcohol (PVOH), a latex, polysaccharide polymers, cellulosic polymers, protein solution polymers, an acrylic polymer, polymaleic anhydride, epoxy resins, or a combination of two or more thereof. Non-limiting examples of filler may include powders of calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate.

The fibers may be organic fibers, inorganic fibers, or a blend thereof. Non-limiting examples of inorganic fibers mineral wool (also referred to as slag wool), rock wool, stone wool, and glass fibers. Non-limiting examples of organic fiber include fiberglass, cellulosic fibers (e.g., paper fiber—such as newspaper, hemp fiber, jute fiber, flax fiber, wood fiber, or other natural fibers), polymer fibers (including polyester, polyethylene, aramid—i.e., aromatic polyamide, and/or polypropylene), protein fibers (e.g., sheep wool), and combinations thereof.

The porosity of the body 100 may allow for airflow through the body 100 under atmospheric conditions such that the building panel 10 may function as an acoustic building panel—specifically, an acoustic ceiling panel 10, which requires properties related to noise reduction and sound attenuation properties—as discussed further herein.

Specifically, the body 100 of the present invention may have a porosity ranging from about 60% to about 98%—including all values and sub-ranges there between. In a preferred embodiment, the body 100 has a porosity ranging from about 75% to 95%—including all values and sub-ranges there between. According to the present invention, % porosity is defined according to the following formula:

% Porosity=[V_{Total}−(V_{Binder}+V_{F}+V_{Filler})]/V_{Total}

The V_{Total} refers to the total volume of the body 100 defined by the upper surface 111, the lower surface 112, and the body side surfaces 113. V_{Binder} refers to the total volume occupied by the binder in the body 100. V_{F} refers to the total volume occupied by the fibers in the body 100. V_{Filler} refers to the total volume occupied by the filler in the body 100. V_{HC} refers to the total volume occupied by the hydrophobic component in the body 100. Thus, the % porosity represents the amount of free volume within the body 100.

The building panel 10 of the present invention comprising the body 100 may exhibit sufficient airflow for the building panel 10 to have the ability to reduce the amount of reflected sound in a room. The reduction in amount of reflected sound in a room is expressed by a Noise Reduction Coefficient (NRC) rating as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The building panel 10 of the present invention exhibits an NRC of at least about 0.5. In a preferred embodiment, the building panel 10 of the present invention may have an NRC ranging from about 0.60 to about 0.99—including all value and sub-ranges there-between.

The coating 200 of the present invention may be applied to at least one of the upper surface 111, lower surface 112, and/or the body side surface 113 of the body 100. In some embodiments, the surface coating 200 of the present invention may be applied directly to at least one of the upper surface 111 and/or the body side surface 113 of the body 100. Although not pictured, in some embodiments, the building panel 10 may further comprise a scrim. The scrim may comprise a first major surface opposite a second major surface. In certain embodiments, the scrim is made of non-woven material. In certain embodiments, the scrim is immediately adjacent to at least one of the upper surface 111 and the lower surface 112 of the body 100. In certain embodiments, the second major surface of the scrim contacts a surface, such as the upper surface 111, of the body 100. In such non-limiting embodiments, the surface coating 200 may be applied to the first major surface of the scrim.

The coating 200 may comprise an outer surface 201 opposite an inner surface 202. The inner surface 202 of the surface coating 200 faces toward the body 100 while the outer surface 201 of the surface coating 200 faces away from the body 100. The surface coating 200 may comprise a topcoat 210. The topcoat 210 may comprise an outer surface 211 opposite an inner surface 212. The topcoat 210 may have a topcoat thickness t; as measured between the inner surface 212 and the outer surface 211 of the topcoat 210.

The topcoat 210 may be applied to the upper surface 111 of the body 100 or the first major surface of the scrim. Once applied, the inner surface 212 of the topcoat 210 faces the upper surface 111 of the body 100 or the first major surface of the scrim, and the outer surface 211 of the topcoat 210 forms the first major exposed surface 11 of the building panel 10. Stated otherwise, the first major exposed surface 11 of the building panel 10 may comprises the outer surface 211 of the topcoat 210.

The surface coating 200 may comprise an edge-coat 230. The edge-coat 230 may comprise an outer surface 231 opposite an inner surface 232. The edge-coat 230 may be applied to the body side surface 113 of the body 100. Once applied, the inner surface 232 of the edge-coat 230 faces the body side surface 113 of the body 100 and the outer surface 231 of the edge-coat 230 forms the side exposed surface 13 of the building panel 10. Stated otherwise, the side exposed surface 13 of the building panel 10 may comprise the outer surface 231 of the edge-coat 230.

Although the building panel 10 shown in FIGS. 1 and 2 include both the topcoat 210 and the edge-coat 230, the present invention is not limited to surface coatings 200 that include both the topcoat 210 and the edge-coat 230. In some embodiments, the building panel 10 may comprise a surface coating 200 that includes only the topcoat 210—whereby the side exposed surface 13 of the building panel 10 is formed by the body side surface 113 of the body 100. In other embodiments, the building panel 10 may comprise a surface coating 200 that includes only the edge-coat 230—whereby first major exposed surface 11 of the building panel 10 is formed by either the upper surface 111 of the body 100, the first major surface of the scrim, or a coating applied thereto that is different from the surface coating 200 of the present invention.

The coating 200 is formed from a coating composition that may comprise an antimicrobial composition; a binder; and a pigment, wherein the antimicrobial composition comprises particles selected from the group consisting of consisting of an aluminum silicate, a magnesium silicate, and a combination thereof, and wherein the particles are modified with a quaternary ammonium salt. In some embodiments, the coating 200 may further comprise a hydrophobic agent, a dispersant, and/or a filler.

In certain embodiments, the coating 200 may be formed by mixing components in either a solid state, liquid state, a liquid having solids, or an emulsion. In further embodiments, the coating 200 may be formed by mixing components together in a liquid state, where components are added based on solid mass, active compound, or both. In this embodiment, the composition may be dried to achieve a composition having 100% solids content. Subsequentially, the 100% solid composition may be mixed with a solvent to achieve a composition having less than 100% solids amount. The mixed composition may then be applied to a substrate and dried. In some embodiments, application is performed by spraying or applied as a drawdown. The surface coating 200, in the dried state, or dry-state, may be present on the upper surface 111 of the body 100 (as a face coating 210) in an amount ranging from about 26 g/m² to about 450 g/m²—including all amounts and sub-ranges there-between. In certain embodiments, the coating is present on the substrate in an amount ranging from about 50 g/m² to about 400 g/m². According to the present invention, the phrase “dry-state” indicates a composition that is substantially free of a liquid carrier (e.g., liquid water). Thus, the face coating 210 in the dry-state may comprise all dry components (e.g., binder, antimicrobial composition, pigment) and less than about 0.1 wt. % of liquid carrier based on the total weight of the surface coating 200, In a preferred embodiment, the surface coating 200 in the dry-state has a solid's content of about 100 wt. % based on the total weight of the surface coating 200. Conversely, a composition that is in a “wet-state,” which refers to a composition containing various amounts of liquid carrier—as discussed further herein.

The antimicrobial composition comprises silicate particles. In certain embodiments, the silicate particles are metal silicates. In certain embodiments, the silicate particles are selected from the group consisting of an aluminum silicate, a magnesium silicate, a calcium silicate, and a mixture or combination thereof, wherein the particles are modified with a quaternary ammonium salt. Modification of silicate particles, such as aluminum silicate and magnesium silicate, have been described (see, for example Yu et al., Int. J. Environ. Res. Public Health, 2020, 17, 1732; Gackowski and Datka, Molecules, 2020, 25, 1044; and Adins offerings from Tolsa Group, Madrid Spain). Non-limiting examples of aluminum silicate include clay and pyrophyllite. Non-limiting examples of magnesium silicate include sepiolite and talc. Non-limiting examples of clay include sepiolite, kaolin, a smectite (e.g., bentonite, montmorillonite, hectorite, laponite, biedellite, saponite, stevensite), an illite, a pyrophyllite, attapulgite, palygorskite, dickite, saponite, montmorillonite, nacrite, kaolinite, anorthite, halloysite, metahalloysite, chrysotile, lizardite, serpentine, antigorite, beidellite, stevensite, hectonite, smecnite, nacrite and sepiolite, montmorillonite, sauconite, stevensite, nontronite, saponite, hectorite, vermiculite, sericite, glauconite-montmorillonite, roselite-montmorillonite, Bentone 38 (hectorite) and Bentone 34 (bentonite), chlorite-vermiculite, halloysite-montmorillonite, and kaolinite-montmorillonite. Non-limiting examples of silica include zeolite. The aluminum silicate, a magnesium silicate, or combination thereof salt may be present in various amounts and concentrations. In certain embodiments, the particle is present in an amount from about 0.3 to about 5.0%, from about 0.3 to about 3.0%, or from about 0.5 to about 2.8%, based on the total weight of the coating.

In certain embodiments, the quaternary ammonium salt is selected from tetramethylammonium iodide, trimethyldecylammonium bromide, didecyldimethylammonium bromide (DDAB), dodecyldimethyl-2-phenoxyethylammonium bromide, lauryltrimethylammonium bromide, cetyltrimethylammonium bromide, didecyldimethylammonium chloride (DDAC), trimethylammonium chloride, trimethyldodecylammonium chloride, trimethyltetradecylammonium chloride, cetylpyridinium chloride, trimethylhexadecylammonium chloride, trimethyloctadecylammonium chloride, didecylmonomethylhydroxyethylammonium bromide, alkyldimethylhydroxyethylammonium chlorides, alkyltrimethylammonium bromides, dioctyldimethylammonium chloride, dioctyldimethylammonium bromide, octyldecyldimethylammonium chloride, octyldecyldimethylammonium bromide, methylbenzethonium chloride, alkyldimethylbenzylammonium chlorides (BAC), alkylpyridiniumammonium chlorides, dialkylmethylbenzylammonium chlorides, didecyldimethylammonium adipate (DDAA), didecyldimethylammonium gluconate, didecyldimethylammonium propionate, N,N-didecyl-N-methyl-poly(oxyethyl)ammonium propionate, didecylmonomethylhydroxyethylammonium adipate, didecylmonomethylhydroxyethylammonium gluconate, didecylmonomethylhydroxyethylammonium sulfonate, alkyldimethylhydroxyethylammonium adipates, alkyldimethylhydroxyethylammonium gluconates, alkyltrimethylammonium adipates, alkyltrimethylammonium gluconates, dioctyldimethylammonium adipate, dioctyldimethylammonium gluconate, octyldecyldimethylammonium adipate, octyldecyldimethylammonium gluconate, didecylmethylpolyoxyethyleneammonium, didecylmethylpolyoxyethyleneammonium gluconate, and didecylmethylpolyoxyethyleneammonium propionate. In certain embodiments, the quaternary ammonium salt is a cetyltrimethylammonium halogen. In certain embodiments, the quaternary ammonium salt is cetyltrimethylammonium bromide. The quaternary ammonium salt may be present in various amounts and concentrations. In certain embodiments, the quaternary ammonium salt is present in an amount from about 0.05 to about 7.5%, from about 0.1 to about 3.0%, from about 0.1 to about 1.0%, or from about 0.1 to about 0.8%, based on the total weight of the coating. In further embodiments, the quaternary ammonium salt is present in an amount from about 0.05 to about 7.5%, from about 0.05 to about 5.0%, from about 0.1 to about 3.0%, from about 0.05 to about 1.0%, from about 0.1 to about 1.0%, from about 0.1 to about 0.8%, from about 0.05 to about 0.5%, or from about 0.05 to about 0.1%, based on the total weight of the coating. In certain embodiments, the quaternary ammonium salt is present in an amount from about 0.05 to about 7.5%, from about 0.05 to about 5.0%, from about 0.1 to about 3.0%, from about 0.05 to about 1.0%, from about 0.1 to about 1.0%, from about 0.1 to about 0.8%, from about 0.05 to about 0.5%, or from about 0.05 to about 0.1%, based on the total weight of the coating having about 60 to about 66 wt. % solids, with about 64 wt. % preferable.

In certain embodiments, the antimicrobial composition may contain one more molecules in addition to the modified particles. However, such molecules should not negatively affect the aesthetic and/or antimicrobial properties which the coating composition exhibits. Typically, such molecules comprise less than 50 wt. %, less than 25 wt. %, less than 10 wt. %, or less than 5 wt. % of the antimicrobial composition. In certain embodiments, the antimicrobial composition may comprise docusate, quartz, a silver-based compound, an additional antimicrobial (also referred to as a protective component below), or a combination thereof. In certain embodiments, the docusate is sodium docusate, optionally present in an amount from about 0.01 to about 3%, based on the total weight of the antimicrobial composition. In certain embodiments, the silver-based compound is a silver halogen, such as a silver chloride, optionally present in an amount from about 0.01 to about 5.0%, based on the total weight of the antimicrobial composition. In certain embodiments, the quartz is present in an amount from about 0.01 to about 1.0%, based on the total weight of the antimicrobial composition. In certain embodiments, the additional antimicrobial is selected from zinc borate, propiconazole, 2,2-dibromo-3-nitrilopropionamide, copper-glass, or a mixture thereof. In certain embodiments, the antimicrobial composition further comprises zinc borate, other zinc compounds, copper oxide, silver compounds, propiconazole, triazoles, bromine compounds, other quaternary amine or quaternary bromide compounds, copper oxide (such as, but not limited to, copper I oxide), or a mixture or combination thereof. In certain embodiments, the particles are further modified with a triazole, such as propiconazole. In certain embodiments, the additional antimicrobial is present in an amount of from about 0.01% to about 12.0%, from about 0.05% to about 10.0%, or from about 0.01% to about 10.0%, based on the total weight of the coating. In certain embodiments, the antimicrobial composition is free of triazole compounds. In some embodiments, the antimicrobial composition is substantially free of triazole compounds. In some embodiments, the antimicrobial composition is substantially free of sulfur-containing benzimidazole compounds. In some embodiments, the antimicrobial composition is substantially free of 2,2-dibromo-3 nitrilopropionamide.

As discussed, the present invention makes use of silicate particles which are modified to have absorbed quaternary ammonium salt attached thereto. The mass ratio of the silicate particles to quaternary ammonium salt may vary. In certain embodiments, the mass ratio of the silicate particles to quaternary ammonium salt is from about 30:1 to about 2:1, from about 20:1 to about 2:1, from about 10:1 to about 2:1, from about 7:1 to about 3:1, from about 6:1 to about 4:1, or from about 5.6:1 to about 3.75:1.

The antimicrobial composition may constitute various amounts of the coating composition. In certain embodiments, the antimicrobial composition is present in an amount from about 0.1 to about 50 parts, from about 0.1 to about 20 parts, or from about 0.1 to about 10 parts, based on the total weight of the coating. In certain embodiments, the antimicrobial composition is present in an amount from about 0.3 to about 15%, from about 8 to about 15%, from about 10 to about 15%, from about 11 to about 14%, from about 0.3 to about 10%, from about 0.3 to about 8%, from about 0.3 to about 5%, or from about 0.3 to about 3%, based on the total weight of the coating.

The binder may be present in the surface coating 200 in an amount ranging from about 5 wt. % to about 20 wt. % based on the total dry-weight of the surface coating 200—including all wt. % and sub-ranges there-between. The binder may be polymeric. The binder may have a glass transition temperature (“Tg”) that is greater than room temperature (“Tm”)—wherein room temperature ranges from about 21° C. to about 40° C.—including all temperatures and sub-ranges there-between. In some embodiments, the binder may have an overall charge that is anionic.

Non-limiting examples of the binder suitable for the coating 200 may include polymers selected from polyvinyl alcohol (PVOH), latex, an acrylic polymer, polymaleic anhydride, or a combination of two or more thereof. Non-limiting examples of latex binder may include a homopolymer or copolymer formed from the following monomers: vinyl acetate (i.e., polyvinyl acetate), vinyl propinoate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methacrylate, hydroxyethyl acrylate, styrene, butadiene, urethane, epoxy, melamine, and an ester. In certain embodiments, the binder is selected from vinyl acetate, vinyl propionate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methacrylate, hydroxyethyl acrylate, styrene, butadiene, urethane, epoxy, melamine, and a combination of two or more thereof. In certain embodiments, the binder has a glass transition temperature (Tg) from about 30° C. to about 55° C. In certain embodiments, the binder has a Tg of about 37° C.

As previously described, the antimicrobial composition may further comprise a protective component which may exhibit antimicrobial activity. The protective component may also be referred to as an “antiviral component” when the component exhibits antiviral activity. The protective component may also be referred to as an “antibacterial component” when the component exhibits antibacterial activity. The protective component may also be referred to as an “antifungal component” when the component exhibits antifungal activity.

In certain embodiments, the protective component may comprise a metal borate. In some embodiments, the protective component may consist essentially of the metal borate. In some embodiments, the protective component may consist of the metal borate. Metal borate refers to a compound corresponding to basic, dibasic, tribasic and polybasic metal borate(s), and mixtures thereof. For example, “zinc borate” may refer to a group of compounds consisting of zinc borate (ZnB₄O₇), any of the corresponding basic zinc borates (such as monobasic zinc borate of the structure Zn(OH)·B₄O₇, dibasic basic zinc borate of the structure 2Zn(OH)₂·B₄O₇, tribasic zinc borate of the structure 3Zn(OH)₃·B₄O₇ and the like), and mixtures thereof. As another example, “copper borate” may also be utilized. Non-limiting examples of copper borate include CuB₂O₄, CuBO₂, Cu₃B₂O₆, CuB₄O₇, any of its the corresponding basic copper borates (such as monobasic copper borate of the structure Cu(OH)·B₄O₇, dibasic basic copper borate of the structure 2Cu(OH)₂·B₄O₇, tribasic copper borate of the structure 3Cu(OH)₃·B₄O₇, and the like), and mixtures thereof. The metal borate may include more than one metal. In a preferred embodiment, the metal borate is zinc borate. The metal borate may be present in an amount of from about 0.3 wt. % to about 50 wt. %, from about 0.3 wt. % to about 20 wt. %, from about 0.1 wt. % to about 15 wt. %, from about 5 wt. % to about 12 wt. %, from about 5 wt. % to about 10 wt. %, or from about 8 wt. % to about 11 wt. %, based on the total weight of the antimicrobial composition. In certain embodiments, the metal borate may be present in an amount from about 8 to about 45 wt. %, based on the total weight of the antimicrobial composition.

The pigment may be present in the surface coating 200 in an amount ranging from about 10 wt. % to about 75 wt. %—including all wt. % and sub-ranges there-between—based on the total dry-weight of the coating 200. Similar to the phrase “dry-state”—the phrase “dry-weight” refers to the weight of a component or composition without including any additional weight of liquid carrier. Thus, when calculating the dry weight of a component or composition, the calculation should be based solely on the weight of the solid components (e.g., pigment, binder, etc.), and should exclude any amount of residual liquid carrier that may still be present from the wet-state. In other embodiments, the pigment is present in an amount ranging from about 10 to about 25%, based on the total weight of the coating composition, which may include liquid carrier.

The pigment may be an inorganic pigment. The pigment may be selected from one or more of particles of carbon black, graphite, graphene, copper oxide, copper oxide containing glasses, iron oxide, zinc oxide, calcium carbonate, manganese oxide, titanium dioxide, calcium carbonate, silver halides, silver containing glasses, and combinations thereof. The inorganic pigments may include individual particles having colors selected from, but not limited to, red, blue, yellow, black, green, brown, violet, white, grey and combinations of two or more thereof.

The coating 200 may further comprise a dispersant. The dispersant may be present in the coating 200 in an amount ranging from about 0.1 wt. % to about 2.0 wt. % based on the total dry-weight of the coating 200—including all wt. % and sub-ranges there-between. In some embodiments, the dispersant may be present in the coating 200 in an amount ranging from about 0.1 wt. % to about 1.0 wt. % based on the total dry-weight of the coating 200—including all wt. % and sub-ranges there-between. The dispersant may be ionic in nature—i.e., comprise one or more ionic groups such as anionic group or cationic group. In a preferred embodiment, the ionic group is anionic.

According to some embodiments, the dispersant may comprise an anionic polyacrylic polymer having a salt group formed from a neutralization of an acid group with a compound forming a cation. For examples, the polymer may comprise one or more pendant side chains comprising a terminal carboxylic acid group that is neutralized with sodium or ammonia to form a carboxylate anion and a sodium cation and/or ammonium cation. Alternatively, the polymer may comprise one or more pendant side chains comprising a terminal sulfonic acid group that is neutralized with the aforementioned sodium or ammonia compounds to form a salt group.

The coating 200 may further comprise a rheology agent. The term “rheology agent” refers to a component capable of modifying the rheological properties (e.g., viscosity) if the coating in the wet-state. The rheology agent may be present in the coating 200 in an amount ranging from about 0.05 wt. % to about 1.0 wt. % based on the total dry-weight of the coating 200—including all wt, % and sub-ranges there-between. In some embodiments, the rheology agent may be present in the coating 200 in an amount ranging from about 0.1 wt. % to about 0.5 wt. % based on the total dry-weight of the coating 200—including all wt. % and sub-ranges there-between.

Non-limiting examples of rheology agents include thickeners. Thickeners include organic thickeners, inorganic thickeners, and synthetic thickeners. Non-limiting examples of organic thickener includes natural cellulose, e.g., hydroxyl ethyl cellulose, carboxymethyl cellulose, and polysaccharides. In preferred embodiments, the thickener is a soluble cellulose ether. Inorganic thickeners may include organoclay and hydrous magnesium aluminum-silicate. Non-limiting examples of synthetic thickeners includes, e.g., acrylic, HEUR, and ASE (Dow Chemical).

The coating 200 may further comprise one or more of an additive include defoamers, wetting agents, flame retardants, and the like. The additive may be present in an amount ranging from about 0.01 wt. % to about 3.0 wt. % based on the total weight of the coating 200.

The coating 200 may further comprise a hydrophobic agent (also referred to as a hydrophobic component). According to the present invention, the term “hydrophobic” means a composition or component that is difficult to wet and is capable of repelling liquid water under atmospheric conditions. Thus, as used herein, the term “hydrophobic” refers to a surface that generates a contact angle of greater than 90° with a reference liquid (i.e., water).

The hydrophobic component may be present in the coating 200 an amount ranging from about 0.1 wt. % to about 10 wt. % based on the total weight of the coating 200—including all value and sub-ranges there-between. In some embodiments, the hydrophobic component may be present in the coating 200 in an amount ranging from about 1 wt. % to about 10 wt. %, based on the total dry-state weight of the coating 200—including all value and sub-ranges there-between. In some embodiments, the hydrophobic component may be present in an amount ranging from about 3 wt. % to about 5 wt. %, based on the total dry-state weight of the coating 200—including all values and sub-ranges there-between. In certain embodiments, the hydrophobic component is present in an amount from about 0.5 to about 10.0%, from about 1.0 to about 8.0%, from about 1.0 to about 6.5%, or from about 1.0 to about 2.0%, based on the total weight of the coating.

Non-limiting examples of the hydrophobic component include waxes, silicones, fluoro-containing additives, and combinations of two or more thereof—as discussed further herein

The wax may have a number average molecular weight ranging from about 100 to about 10,000—including all values and sub-ranges there-between. The wax may have a melting point (Tm) ranging from about 0° C. to about 150° C.—including all values and sub-ranges there-between. In a preferred embodiment, the wax may have a melting point ranging from about 8° C. to about 137° C.—including all values and sub-ranges there-between.

The hydrophobic component may be applied as a water-based emulsion. The emulsion may be anionic or non-ionic. The emulsion may have a solid content (i.e., the amount of wax within the hydrophobic component) ranging from about 20 wt. % to about 60 wt. % based on the emulsion—including all value and sub-ranges there-between. In certain embodiments, the hydrophobic agent is selected from a silicon emulsion, a paraffin emulsion, a polyethylene emulsion, a blend of paraffin and polyethylene wax emulsion, and mixtures thereof. In certain embodiments, the hydrophobic component comprises a paraffin and polyethylene wax emulsion.

The defoamer may be present in an amount ranging from about 0.05 wt. % to about 0.2 wt. % (including all values and sub-ranges there-between)—based on the total weight of the coating 200 in the dry-state.

Non-limiting examples of defoamer may include polyalphaolefin formed from one or more monomers of 1-hexene, 1-heptene, 1-octene, 1-nonene, 1-decene, 1-undecene, 1-tridecene, 1-tetradecene, 1-pentadecene, 1-hexadecene, 1-octadecene, 1-heptadecene, and 1-nonadecene; a high density polymer selected from oxidized ethylene homopolymers, polyethylene homopolymers, and polypropylene homopolymers; a silicone oil, polypropylene glycol, and diethylenetriamine; and a non-ionic surfactant compound selected from polyether modified polysiloxane, polyethylene glycol oleate, and polyoxypropylene-polyoxyethylene copolymer—as well as mixtures thereof.

The coating of the present invention may further comprise filler. The filler may comprise one or more inorganic particles. Non-limiting examples of such inorganic particles include limestone, calcium carbonate, clay, dolomite, talc, perlite, gypsum, calcite, aluminum trihydrate, zinc oxide, and combinations of two or more thereof. In certain embodiments, the filler is selected from calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, zinc sulfate, aluminum hydroxide, and combinations of two or more thereof. The filler may be present in an amount ranging from about 0.01% to about 80% (including all values and sub-ranges there-between)—based on the total weight of the coating 200 in the dry-state. In certain embodiments, the filler is present in an amount ranging from about 25 to about 60%, from about 30 to about 55%, or from about 30 to about 50%, based on the total weight of the coating.

In certain embodiments, the inorganic particle has a disk shape (also referred to as “plate shape”), The term “disk shape” refers to a three-dimensional shape, whereby the shape has an aspect ratio ranging from about 1,000 to about 1—including all ratios and sub-ranges there-between. The term “aspect-ratio” refers to the ratio of particle diameter (or length, or width) compared to particle thickness. While the ultimate shape of each particle may vary, high aspect ratios—e.g., about 50 to 1—result in discrete thin plate-like particles having a substantially flat major surface and a relatively short side surface. The inorganic particles having a disk shape whereby the shape exhibits a major surface having an area per unit of weight (m²/g) that ranges from about 5 m²/g to about 9 m²/g—including all values and sub-ranges there-between. In some embodiments, the disk shape may have a major surface with an area per unit of weight of about 7 m²/g. The inorganic particles having the disk shape may have an average diameter ranging from about 1 micron (μm) to about 10 μm—including all integers and sub-ranges there-between. In one embodiment, the inorganic particles having the disk shape may have an average diameter of about 4 μm. The inorganic particles having the disk shape may be comprised of one or more of kaolin, aluminum silicates, kaolinite, aluminum hydroxide, aluminum oxide, and combinations thereof. In a preferred embodiment, the inorganic particles are comprised of aluminum hydroxide. In certain embodiments, the aluminum hydroxide is present in an amount from about 5 to about 15%, from about 7 to about 12%, or from about 7.5 to about I %, based on the total weight of the coating composition.

The surface coating 200 may be formed by applying a coating composition in the wet-state. The coating composition may comprise the dry components of the surface coating 200 (e.g., the binder, the antimicrobial composition, the pigment, the dispersant, etc.) blended with a liquid carrier. The liquid carrier may be selected from water, VOC solvent—such as acetone, toluene, methyl acetate—or combinations thereof. In some embodiments, the liquid carrier may be water and comprises less than 1 wt. % of VOC solvent based on the total weight of the liquid carrier.

The coating composition may have a solid's content of at least 50 wt. % based on the total weight of the coating composition in the wet-state. Stated otherwise, the liquid carrier is present in a maximum amount of about 50 wt. % based on the total weight of the coating composition in the wet-state.

The solids content of the coating composition in the wet-state may range from about 15 wt. % to about 80 wt. %—including all wt. % and sub-ranges there-between. In a preferred embodiment, the solids content of the coating composition in the wet-state may range from about 20 wt. % to about 70 wt. % based on the total weight of the coating composition—including all wt. % and sub-ranges there-between. In some embodiments, the coating composition in the wet-state may have a solids content ranging from 54 wt. % to about 68 wt.—including all wt. % and sub-ranges there-between. % based on the total weight of the coating composition.

The solid's content is calculated as the fraction of components present in the wet-state coating composition that are not the liquid carrier. For example, the solid's content of the wet-state coating composition may be calculated as the amount of binder, filler, pigment, dispersant, defoamer, antimicrobial composition, flame retardant, in the dry-state coating composition and dividing it by the total weight of the coating composition in the wet-state (including both solid components and liquid carrier),

Therefore, the amount of each component in the wet-state coating may be calculated by multiplying the desired amount of each of the dry component (e.g., pigment, antimicrobial composition) that is present in the coating 200 in the dry-state by the total solids content of the coating composition in the wet-state. For example, for a coating 200 in the dry-state comprising about 70 wt. % of pigment, whereby that coating 200 is applied as a wet-state coating composition having a solids content of 65 wt. %—the amount of the pigment in the wet-state coating composition would be 45.5 wt. % based on the total weight of the coating composition in the wet-state—i.e., 70 wt. %×0.65=45.5 wt. % of pigment in the coating composition in the wet-state.

The coating composition in the wet-state may have a pH ranging from about 6.0 to about 10.0—including all pH values and sub-ranges there-between. In some embodiments, the coating composition in the wet-state may have a pH value ranging from The coating composition in the wet-state may have a pH ranging from about 8.0 to about 9.0—including all pH values and sub-ranges there-between. The coating composition in the wet-state may have a density ranging from about 8.5 to 15 lb./gal—including all densities and sub-ranges there-between.

The coating composition in the wet-state may be applied to one of the upper surface 121, the lower surface 122, and/or the side surface 123 of the body 120 in an amount ranging from about 10 g/m² to about 450 g/m²—including all sub-ranges and values there-between. The coating composition in the wet-state may be applied by roll coating, brush coating, and spray coating, and/or curtain blade. In certain embodiments, a secondary coating may be applied over the coating composition, which yields a coating composition comprising a primary coating composition which contacts the body 100 and a secondary coating composition which contacts the primary coating. In such embodiments, the primary coating may be applied in an amount ranging from about 10 g/m² to about 30 g/m²—including all sub-ranges and values there-between, and the secondary coating composition is applied in an amount ranging from about 10 g/m² to about 30 g/m²—including all sub-ranges and values there-between.

Specifically, the coating composition may be dried from the wet-state to the dry-state in a conventional oven at a first elevated temperature for a first drying period. The first elevated temperature may range from about 67° C. to about 232° C.—including all sub-ranges and temperature there-between. In some embodiments, the first elevated temperature may range from about 67° C. to about 190° C. including all sub-ranges and temperature there-between. In some embodiments, the first elevated temperature may range from about 93° C. to about 232° C.—including all sub-ranges and temperature there-between.

The first drying period may range from about 10 seconds to about 120 seconds—including all sub-ranges and temperature there-between.

The coating 200 in the dry-state may be substantially continuous. The term “substantially continuous” refers to less than 5% of the available surface area on the referenced surface contains pin-holing or blistering. The coating 200 may be substantially continuous such that the acoustic properties of the body 120 are not substantially hindered, thereby allowing the resulting building panel 100 to also function as an acoustical building panel. Stated otherwise, even with the surface coating 200 applied to one or more of the upper surface 121, the lower surface 122, and/or the side surface 123 of the body 120, the overall building panel 100 may still exhibit acoustical properties (i.e., NRC and CAC performance) substantially equal to and/or overlapping with that of the naked body

The building panel of the present invention may be a ceiling panel or tile, wall panel, wall covering (e.g., wallpaper) or directly to a wall (e.g., painted dry wall, wood wall paneling, such as wainscot, baseboard molding, crown molding). In other embodiments, the coating composition may be applied directly to a glass surface (e.g., a door, a window, etc.). In other embodiments of the present invention, the coating composition may be applied various textiles—such as felts, upholstery, or window hangings (e.g., curtains), and various paper products (e.g., paper towels, coated paper, cardboard, and the like), decorative shower-curtaining liners. In other embodiments, the coating composition may be applied to a window blind (formed from cellulosic material, polymeric material, or inorganic material). The coating composition may be applied to other various indoor surfaces for the purpose of reducing VOCs and odor in a closed-environment. In other embodiments, the coating composition may be applied to packaging products (e.g., styrofoam, recycled packaging).

In other embodiments, the invention further includes a method of forming a coating composition according to any one of the embodiments disclosed herein, wherein the method comprises mixing the components with a liquid carrier. In certain embodiments, the components are mixed with the liquid carrier to achieve a total solids amount of from about 55 to about 75 wt. %, from about 58 to about 70 wt. %, or from about 60 to about 66 wt. %. In further embodiments, the invention is directed to a method of forming a coated building panel comprising applying the coating composition according to any one of the embodiments disclosed herein to a substrate; and drying the coating composition so that substantially all liquid carrier is removed to form the coated building panel. In certain embodiments, the drying is performed at a temperature ranging from about 80° C. to about 135° C.

The following examples further describe and demonstrate illustrative embodiments within the scope of the present invention. The examples are given solely for illustration and are not to be construed as limitations of this invention as many variations are possible without departing from the spirit and scope thereof. Various modifications of the invention in addition to those shown and described herein should be apparent to those skilled in the art and are intended to fall within the appended claims.

### Examples

The examples and other implementations described herein are exemplary and not intended to be limiting in describing the full scope of compositions and methods of this disclosure. Equivalent changes, modifications and variations of specific implementations, materials, compositions, and methods may be made within the scope of the present disclosure, with substantially similar results.

Example 1: Various coating compositions were prepared as described in Table 1. All values are presented as a dry weight percent of solids. All coating compositions were then sprayed onto a substrate. Biocide 1, which contains a quaternary ammonium (e.g., cetyltrimethylammonium bromide), comprises particles of sepiolite (a hydrous magnesium silicate), present in an amount from about 73 to about 85 wt. %, modified with the quaternary ammonium, which is present in an amount of about 15 to about 20 wt. %, along with minor amounts of sodium docusate, silver chloride, and quartz (each present in an amount of less than about 3 wt. %).

TABLE 1
Coating compositions.

| | Comparative | | | | |
|---|---|---|---|---|---|
| Component | Example 1 | Example 1 | Example 2 | Example 3 | Example 4 |
| TiO₂ and CaCO₃ | 26.80% | 26.80% | 26.80% | 26.80% | 26.80% |
| mixture | | | | | |
| CaCO₃ (solid) | 18.89% | 18.89% | 18.89% | 18.89% | 18.89% |
| CaCO₃ (slurry) | 16.24% | 18.10% | 18.27% | 21.10% | 16.60% |
| Carboxylated | 12.19% | 12.19% | 12.19% | 12.19% | 12.19% |
| polyvinyl acetate | | | | | |
| homopolymer, | | | | | |
| Tg 37° C. | | | | | |
| Sodium polyacrylate | 0.1165% | 0.1165% | 0.1165% | 0.1165% | 0.1165% |
| Water soluble | 0.1669% | 0.1669% | | 0.1669% | 0.1669% |
| cellulose ether | | | | | |
| Polyether siloxane | 0.0186% | 0.0186% | 0.0186% | 0.0186% | 0.0186% |
| TiO₂ | 1.4902% | 1.4902% | 1.4902% | 1.4902% | 1.4902% |
| Aluminum | 9.42% | 9.42% | 9.42% | 9.42% | 9.42% |
| hydroxide | | | | | |
| Paraffin and | — | — | — | — | 1.50% |
| polyethylene wax | | | | | |
| emulsion | | | | | |
| Water Repellant | 4.56% | — | — | — | — |
| Emulsion | | | | | |
| Biocide 1: | — | 3.0% | 3.0% | — | 3.0% |
| Quaternary | | | | | |
| ammonium absorbed | | | | | |
| on silicate particles | | | | | |
| Biocide 2: Zinc | 9.55% | 9.07% | 9.07% | 9.07% | 9.07% |
| borate | | | | | |
| Biocide 3: | 0.47% | — | — | — | — |
| Propiconazole | | | | | |
| Biocide 4: 2,2- | 0.081% | 0.732% | 0.732% | 0.732% | 0.732% |
| Dibromo-3- | | | | | |
| nitrilopropionamide | | | | | |
| | — | — | — | — | — |
| Density | 11.98 | 11.14 | 9.51 | 10.61 | 9.70 |
| pH | 8.34 | 7.89 | 7.9 | 7.90 | 8.09 |

The coating compositions of Table 1 were sprayed onto a scrim substrate (which yields non-continuous coverage) and characterized. The results are summarized in Table 2.

TABLE 2
Performance characterization of coating compositions.

| | Control | Example 1 | Example 2 | Example 3 | Example 4 |
|---|---|---|---|---|---|
| White color | | | | | |
| characteristics | | | | | |
| L | 97.03 | 96.38 | 96.08 | 96.05 | 95.2 |
| a | −0.56 | −0.46 | −0.42 | −0.24 | −0.29 |
| b | 1.98 | 1.91 | 2.5 | 2.4 | 2.8 |
| Y | 92.51 | 90.93 | 90.21 | 90.12 | 88.1 |
| Black color | | | | | |
| characteristics | | | | | |
| L | 96.42 | 96.02 | 95.22 | 95.39 | 93.67 |
| a | −0.73 | −0.65 | −0.65 | 1.98 | −0.58 |
| b | 1.45 | 1.63 | 1.81 | 88.56 | 1.77 |
| Y | 91.03 | 90.09 | 88.14 | 88.56 | 84.51 |
| Opacity | 98.4 | 99.1 | 97.7 | 98.3 | 95.9 |
| Gloss | | | | | |
| 20° | 1.3 | 1.3 | 1.3 | 1.3 | 1.3 |
| 60° | 2.4 | 2.4 | 2.5 | 2.3 | 2.4 |
| 85° | 4.5 | 5.6 | 4.4 | 3.5 | 3.1 |

As demonstrated in Table 2, use of the various biocides did not have a detrimental impact to the color, opacity, and gloss performance of the coating composition. Surprisingly and unexpectedly, use of biocide 1 provided for enhanced opacity and gloss (i.e., Example 1 and 3).

Example 2: Various compositions were further prepared as described in Table 3. All values are presented as a dry weight percent of solids. Where modification to the comparative example 2 composition were made, such as for adding or eliminating components, the total amount of calcium carbonate slurry was adjusted to achieve 100% solids. The compositions were applied to a substrate either by spray or drawdown (continuous coating layer applied to substrate using a scraper bar) and analyzed for antimicrobial, antiviral, antifungal properties. Antimicrobial testing was performed against Staphylococcus aureus ATCC 6538 according to procedures established by ASTM E2180-18 and/or JIS Z 2801:2010. Antifungal activity was performed against Aspergillus niger, Penicillium citrinum, and Aureobasidium pullulans according to procedures established by ASTM D3273. For the antifungal activity, ratings were derived ranging from 0 to 10, where 10 represents no defacement (no mold growth) and 0 represents 91-100% defacement. Results of the testing is shown in Table 4.

TABLE 3
Coating compositions.

| | Comparative | | | | | | |
|---|---|---|---|---|---|---|---|
| Component | Example 2 | Ex. 5 | Ex. 6 | Ex. 7 | Ex. 8 | Ex. 9 | Ex. 10 |
| TiO₂ and CaCO₃ mixture | 26.7969% | 26.7969% | 26.7969% | 26.7969% | 26.7969% | 26.7969% | 26.7969% |
| CaCO₃ (solid) | 18.8864% | 18.8864% | 18.8864% | 18.8864% | 18.8864% | 18.8864% | 18.8864% |
| CaCO₃ (slurry) | aq. | aq. | aq. | aq | aq | aq. | aq. |
| Carboxylated polyvinyl | 12.1926% | 12.1926% | 12.1926% | 12.1926% | 12.1926% | 12.1926% | 12.1926% |
| acetate homopolymer, | | | | | | | |
| Tg 37° C. | | | | | | | |
| Sodium polyacrylate | 0.1165% | 0.1165% | 0.1165% | 0.1165% | 0.1165% | 0.1165% | 0.1165% |
| Water soluble | 0.1669% | 0.1669% | 0.1669% | 0.1669% | 0.1669% | 0.1669% | 0.1669% |
| cellulose ether | | | | | | | |
| Polyether siloxane | 0.0186% | 0.0186% | 0.0186% | 0.0186% | 0.0186% | 0.0186% | 0.0186% |
| TiO₂ | 1.4902% | 1.4902% | 1.4902% | 1.4902% | 1.4902% | 1.4902% | 1.4902% |
| Aluminum hydroxide | 9.4243% | 9.4243% | 9.4243% | 9.4243% | 9.4243% | 9.4243% | 9.4243% |
| Paraffin and polyethylene | — | 1.5% | 1.5% | 1.5% | 1.5% | 1.5% | 1.5% |
| wax emulsion | | | | | | | |
| Water Repellant Emulsion | 4.5627% | 4.5627% | 4.5627% | 4.5627% | 4.5627% | 4.5627% | 4.5627% |
| Biocide 1: | — | 3% | 1% | 1% | 1% | 1% | 1% |
| Quaternary ammonium | | | | | | | |
| Biocide 2: Zinc borate | 9% | — | 9% | — | — | 9% | 9% |
| Biocide 3: Propiconazole | 0.4742% | — | — | — | — | — | — |
| Biocide 4: 2,2-Dibromo- | 0.0813% | — | 0.813% | — | — | 0.813% | 0.813% |
| 3-nitrilopropionamide | | | | | | | |
| Biocide 5: Copper-glass | — | — | — | — | 0.1% | — | — |

TABLE 4
Antimicrobial, antiviral, and antifungal results.

| | Comp. | | | | | | |
|---|---|---|---|---|---|---|---|
| | Example 2 | Ex. 5 | Ex. 6 | Ex. 7 | Ex. 8 | Ex. 9 | Ex. 10 |
| Bacterial log | N/A | 1.88 | 1.09 | 1.78 | 1.34 | 3.45 | 3.21 |
| reduction as | | | | | | | |
| compared to | | | | | | | |
| Comp. Ex. 2 | | | | | | | |
| Antiviral | >4.0 | >4.0 | >4.0 | >4.0 | >4.0 | >4.0 | >4.0 |
| (Corona 229E) | | | | | | | |

As shown in Table 4, each biocide tested exhibited antimicrobial activity. Furthermore, use of biocide 1 increased the antimicrobial properties of the coatings. Use of Biocides 1, 2, and 3 provided for the greatest reduction in bacterial count. Surprisingly, upon increase of Biocide 1 from 1% to 3%, the viscosity of the composition increased, making use difficult. This was overcome by decreasing the solids content to about 64%.

While the present invention has been described with reference to several embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention is to be determined from the claims appended hereto. Further, it will be apparent to those of skill in the art that numerous changes may be made in such details without departing from the spirit and the principles of the invention.

What is claimed is:

1. A building panel comprising:
a substrate comprising a first major surface opposite a second major surface; and
a coating atop at least one of the first major surface or the second major surface, the coating comprising:
an antimicrobial composition;
a binder; and
a pigment;
wherein the antimicrobial composition comprises particles selected from the group consisting of an aluminum silicate, a magnesium silicate, and a mixture thereof, and
wherein the particles are modified with a quaternary ammonium salt.

2. The building panel according to claim 1, wherein the quaternary ammonium salt is selected from tetramethylammonium iodide, trimethyldecylammonium bromide, didecyldimethylammonium bromide (DDAB), dodecyldimethyl-2-phenoxyethylammonium bromide, lauryltrimethylammonium bromide, cetyltrimethylammonium bromide, didecyldimethylammonium chloride (DDAC), trimethylammonium chloride, trimethyldodecylammonium chloride, trimethyltetradecylammonium chloride, cetylpyridinium chloride, trimethylhexadecylammonium chloride, trimethyloctadecylammonium chloride, didecylmonomethylhydroxyethylammonium bromide, alkyldimethylhydroxyethylammonium chlorides, alkyltrimethylammonium bromides, dioctyldimethylammonium chloride, dioctyldimethylammonium bromide, octyldecyldimethylammonium chloride, octyldecyldimethylammonium bromide, methylbenzethonium chloride, alkyldimethylbenzylammonium chlorides (BAC), alkylpyridiniumammonium chlorides, dialkylmethylbenzylammonium chlorides, didecyldimethylammonium adipate (DDAA), didecyldimethylammonium gluconate, didecyldimethylammonium propionate, N,N-didecyl-N-methyl-poly(oxyethyl)ammonium propionate, didecylmonomethylhydroxyethylammonium adipate, didecylmonomethylhydroxyethylammonium gluconate, didecylmonomethylhydroxyethylammonium sulfonate, alkyldimethylhydroxyethylammonium adipates, alkyldimethylhydroxyethylammonium gluconates, alkyltrimethylammonium adipates, alkyltrimethylammonium gluconates, dioctyldimethylammonium adipate, dioctyldimethylammonium gluconate, octyldecyldimethylammonium adipate, octyldecyldimethylammonium gluconate, didecylmethylpolyoxyethyleneammonium, didecylmethylpolyoxyethyleneammonium gluconate, or didecylmethylpolyoxyethyleneammonium propionate.

3. The building panel according to claim 1, wherein the silicate particle is present in an amount from about 0.3 to about 10.0%, based on the total weight of the coating.

4. The building panel according to claim 1, wherein the antimicrobial composition further comprises one or more of docusate, silver chloride, and a metal borate.

5. The building panel according to claim 1, wherein the antimicrobial composition is present in an amount from about 0.3 to about 50%, based on the total weight of the coating.

6. The building panel according to claim 1, wherein the binder comprises a polymeric binder selected from vinyl acetate, vinyl propionate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methacrylate, hydroxyethyl acrylate, styrene, butadiene, urethane, epoxy, melamine, and a mixture of two or more thereof.

7. A coating composition comprising:
a liquid carrier;
an antimicrobial composition;
a binder; and
a pigment;
wherein the antimicrobial composition comprises particles selected from the group consisting of an aluminum silicate, a magnesium silicate, and a mixture thereof, and
wherein the particles are modified with a quaternary ammonium salt.

8. The coating composition according to claim 7, wherein the quaternary ammonium salt is selected from tetramethylammonium iodide, trimethyldecylammonium bromide, didecyldimethylammonium bromide (DDAB), dodecyldimethyl-2-phenoxyethylammonium bromide, lauryltrimethylammonium bromide, cetyltrimethylammonium bromide, didecyldimethylammonium chloride (DDAC), trimethylammonium chloride, trimethyldodecylammonium chloride, trimethyltetradecylammonium chloride, cetylpyridinium chloride, trimethylhexadecylammonium chloride, trimethyloctadecylammonium chloride, didecylmonomethylhydroxyethylammonium bromide, alkyldimethylhydroxyethylammonium chlorides, alkyltrimethylammonium bromides, dioctyldimethylammonium chloride, dioctyldimethylammonium bromide, octyldecyldimethylammonium chloride, octyldecyldimethylammonium bromide, methylbenzethonium chloride, alkyldimethylbenzylammonium chlorides (BAC), alkylpyridiniumammonium chlorides, dialkylmethylbenzylammonium chlorides, didecyldimethylammonium adipate (DDAA), didecyldimethylammonium gluconate, didecyldimethylammonium propionate, N,N-didecyl-N-methyl-poly(oxyethyl)ammonium propionate, didecylmonomethylhydroxyethylammonium adipate, didecylmonomethylhydroxyethylammonium gluconate, didecylmonomethylhydroxyethylammonium sulfonate, alkyldimethylhydroxyethylammonium adipates, alkyldimethylhydroxyethylammonium gluconates, alkyltrimethylammonium adipates, alkyltrimethylammonium gluconates, dioctyldimethylammonium adipate, dioctyldimethylammonium gluconate, octyldecyldimethylammonium adipate, octyldecyldimethylammonium gluconate, didecylmethylpolyoxyethyleneammonium, didecylmethylpolyoxyethyleneammonium gluconate, or didecylmethylpolyoxyethyleneammonium propionate.

9. The coating composition according to claim 7, wherein the quaternary ammonium salt is present in an amount about 0.05 to about 7.5%, from about 0.05 to about 5.0%, from about 0.1 to about 3.0%, from about 0.1 to about 1.0%, or from about 0.1 to about 0.8%, based on the total weight of the coating.

10. The coating composition according to claim 7, wherein the silicate particle is present in an amount from about 0.3 to about 10.0%, from about 0.3 to about 5.0%, from about 0.3 to about 3.0%, or from about 0.5 to about 2.8%, based on the total weight of the coating.

11. The coating composition according to claim 7, wherein the antimicrobial composition further comprises one or more of docusate, silver chloride, and a metal borate.

12. The coating composition according to claim 7, wherein the coating further comprises a hydrophobic agent selected from a silicon emulsion, a paraffin emulsion, a polyethylene emulsion, a blend of paraffin and polyethylene wax emulsion, and combinations of two or more thereof.

13. The coating composition according to claim 7, wherein the antimicrobial composition is present in an amount from about 0.3 to about 50%, from about 0.3 to about 10%, based on the total weight of the coating.

14. The coating composition according to claim 7, wherein the pigment is present in an amount ranging from about 10 to about 25%, based on the total weight of the coating.

15. The coating composition according to claim 7, wherein the coating further comprises a filler selected from calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, zinc sulfate, and mixtures of two or more thereof.

16. The coating composition according to claim 7, wherein the binder comprises a polymeric binder selected from vinyl acetate, vinyl propionate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methacrylate, hydroxyethyl acrylate, styrene, butadiene, urethane, epoxy, melamine, and a mixture of two or more thereof.

17. The coating composition according to claim 7, wherein the coating further comprises a dispersant present in an amount ranging from about 0.05 to about 2.0%, based on the total weight of the coating.

18. The coating composition according to claim 7, wherein the coating further comprises a water soluble cellulose ether present in an amount ranging from about 0.05 to about 2.0%, based on the total weight of the coating.

19. A method for forming a coated building panel comprising:
a) applying a coating composition according to a substrate; and
b) drying the coating composition so that substantially all liquid carrier is removed to form the coated building panel, wherein the coating composition comprises:
a liquid carrier;
an antimicrobial composition;
a binder; and
a pigment;
wherein the antimicrobial composition comprises particles selected from the group consisting of an aluminum silicate, a magnesium silicate, and a mixture thereof, and
wherein the particles are modified with a quaternary ammonium salt.

20. The method according to claim 19, wherein step b) is performed at a temperature ranging from about 80° C. to about 135° C.
